(19) United States
(12) Patent Application Publication
(10) Pub. No.: US 2024/0198761 A1
(43) Pub. Date: Jun. 20, 2024

(54) FAN CONTROL APPARATUS AND A VEHICLE HAVING THE FAN CONTROL APPARATUS

(71) Applicants: HYUNDAI MOTOR COMPANY, Seoul (KR); KIA CORPORATION, Seoul (KR)

(72) Inventors: Kangil Park, Hwaseong-si (KR); Jaehong Choi, Gwangmyeong-si (KR)

(73) Assignees: HYUNDAI MOTOR COMPANY, Seoul (KR); KIA CORPORATION, Seoul (KR)

(21) Appl. No.: 18/370,267

(22) Filed: Sep. 19, 2023

(30) Foreign Application Priority Data
Dec. 19, 2022 (KR) 10-2022-0178467

(51) Int. Cl. B60H 1/00

(52) U.S. Cl. CPC B60H 1/00828; B60H 1/0073; B60H 1/00735

(57) ABSTRACT

A fan control apparatus of a vehicle monitors a state of a fan of an air conditioner and controls operation of the fan based on the monitored state of the fan. A vehicle includes an air conditioner including a motor coupled fan, a current sensor, a speed sensor, a voltage sensor, a communication device, a memory, and a fan control apparatus. The fan control apparatus is configured to identify a positional change of the first performance point periodically generated on the first reference performance curve map, identify a positional change of the second performance point periodically generated on the second reference performance curve map, and determine if performance degradation of the fan occurs based on the positional change of the first performance point and the positional change of the second performance point.

### CROSS-REFERENCE TO RELATED APPLICATION

This application claims priority to and the benefit of Korean Patent Application No. 2022-0178467, filed on Dec. 19, 2022 in the Korean Intellectual Property Office, the disclosure of which is incorporated by reference in its entirety.

### TECHNICAL FIELD

Embodiments of the present disclosure relate to a fan control apparatus, which monitors a state of a fan of an air conditioner and controls operation of the fan based on the monitored state of the fan and relate to a vehicle having the same.

### BACKGROUND

In general, a vehicle is provided with a heating, ventilating, and air conditioning system (HVAC) to make the interior space of the vehicle comfortable.

The heating, ventilating, and air conditioning system (HVAC) is also called an air conditioner.

The air conditioner includes an air conditioning case including an air inlet and an air outlet, an evaporator, and a heater installed inside the air conditioning case. The air conditioner also includes a temperature door installed between the evaporator and the heater to adjust a temperature and includes a damper installed at the air outlet to adjust an opening of the air outlet according to an air conditioning mode.

The air conditioner provides comfort to occupants by providing cool air to the interior of the vehicle in summer and provides warmth to occupants by providing warm air to the interior of the vehicle in winter.

In addition, the air conditioner forcibly sucks air from inside or outside the vehicle into the duct (air conditioning case) to purify and dehumidify. The air conditioner supplies the purified and dehumidified air to the interior space of the vehicle to create a pleasant indoor air environment of the vehicle. The air conditioner prevents and eliminates fogging on a windshield glass of the vehicle and prevents and eliminates the formation of frost on the windshield glass of the vehicle.

Recently, the vehicles monitor a state of the fan using fan data accumulated and stored in a memory. For this reason, the memory of the vehicle with a large physical data space is required.

In addition, there is a problem in that reliability of fan control of the air conditioner is lowered due to performance degradation and deterioration of the fan control apparatus and the memory of the air conditioner.

In addition, there is a problem in that it is difficult to directly determine the efficiency increase of the air conditioner and a hardware fault.

### SUMMARY

It is an aspect of the disclosure to provide a fan control apparatus that determines when a performance degradation of a fan occurs based on performance parameters of a motor. It is another aspect of the present disclosure to increase efficiency of the fan by changing a driving point of the motor in response to performance degradation of the fan. It is another aspect of the present disclosure to provide a vehicle having the same.

It is another aspect of the disclosure to provide a fan control apparatus that diagnoses a fault of the fan control apparatus and responds to the fault of the fan control apparatus by using the fault diagnosis source code for fault diagnosis of the fan control apparatus and the fault response source code for fault response. It is another aspect of the present disclosure to provide a vehicle having the same.

Additional aspects of the present disclosure are set forth in part in the description which follows and, in part, should be apparent from the description or may be learned by practice of the present disclosure.

In accordance with one aspect of the disclosure, a fan control apparatus includes: a communication interface configured to receive performance parameters of a motor provided in a fan; a memory configured to store reference data; and a processor configured to generate first and second reference performance curve maps based on the reference data stored in the memory, periodically generate first and second performance points based on the performance parameters of the motor received by the communication interface, identify a positional change of the first performance point periodically generated on the first reference performance curve map, identify a positional change of the second performance point periodically generated on the second reference performance curve map, and determine whether a performance of the fan is decreased based on the positional change of the first performance point and the positional change of the second performance point.

The performance parameters of the motor of the fan control apparatus may include current data of the motor, voltage data of the motor, and speed data of the motor.

The processor of the fan control apparatus, in response to operation of the fan at an initial time, may obtain first current data, first voltage data, and first speed data of the motor. The processor may also generate a first initial performance point based on the obtained first current data and the obtained first speed data. The processor may also generate a second initial performance point based on the obtained first voltage data and the obtained first speed data.

The processor of the fan control apparatus may set a first boundary area based on position information of the first initial performance point on a first performance map and may set a second first boundary area based on position information of the second initial performance point on a second performance map.

The processor of the fan control apparatus, in response to operation of the fan at a present time, may obtain second current data, second voltage data, and second speed data of the motor. The processor may also generate a first present performance point based on the obtained second current data and the obtained second speed data and may generate a second present performance point based on the obtained second voltage data and the obtained second speed data. In response to mapping the first present performance point to the first performance map, the processor may determine that the performance of the fan is changed based on the first present performance point being located outside the first boundary area of the first performance map. In response to mapping the second present performance point to the second performance map, the processor may determine that the performance of the fan is changed based on the second present performance point being located outside the second boundary area of the second performance map.

The processor of the fan control apparatus, in response to operation of the fan at a present time, may obtain second current data, second voltage data, and second speed data of the motor. The processor may also generate a first present performance point based on the obtained second current data and the obtained second speed data and may generate a second present performance point based on the obtained second voltage data and the obtained second speed data. The processor may also map the first initial performance point and the first present performance point to the first reference performance curve map and may determine a positional change of the first present performance point based on a position of the first initial performance point on the mapped first performance map. The processor may also map the second initial performance point and the second present performance point to the second reference performance curve map and may determine a positional change of the second present performance point based on a position of the second initial performance point on the mapped second performance map. The processor may also determine whether the performance of the fan is decreased based on the positional change of the first present performance point and the positional change of the second present performance point.

The processor of the fan control apparatus may determine a direction of the positional change of the first present performance point corresponding to the positional change of the first present performance point and may determine a direction of the positional change of the second present performance point corresponding to the positional change of the second present performance point.

The processor of the fan control apparatus may determine a cause of a cause of a decrease in performance of the fan corresponding to the direction of the positional change of the first present performance point and the direction of the positional change of the second present performance point based on big data received by a server.

The processor of the fan control apparatus, based on a determination that the performance of the fan is decreased, may obtain a first optimization performance point based on position information of the first initial performance point, may obtain a second optimization performance point based on position information of the second initial performance point, and may update software for controlling the fan based on the first optimization performance point and the second optimization performance point.

The processor of the fan control apparatus may change an operation point of the motor through the update of the software.

The memory of the fan control apparatus may store fault diagnosis source code and fault response source code. The processor of the fan control apparatus may determine faults based of the fault diagnosis source code stored in the memory and may control fault response based on the fault response source code stored in the memory based on a determination of the fault.

In accordance with another aspect of the disclosure, a vehicle includes: an air conditioner including fan coupled to a motor; a current sensor configured to detect a current of the motor; a speed sensor configured to detect a rotational speed of the motor; a voltage sensor configured to detect a voltage of the motor; a communication device configured to receive performance parameters of a motor; a memory configured to store reference data; and a fan control apparatus. The fan control apparatus is configured to generate first and second reference performance curve maps based on the reference data stored in the memory and periodically generate first and second performance points based on the performance parameters of the motor received by the communication device. The fan control apparatus is also configured to identify a positional change of the first performance point periodically generated on the first reference performance curve map and identify a positional change of the second performance point periodically generated on the second reference performance curve map. The fan control apparatus is also configured to determine whether a performance of the fan is decreased based on the positional change of the first performance point and the positional change of the second performance point.

The fan control apparatus of the vehicle, in response to operation of the fan at an initial time, may obtain first current data, first voltage data, and first speed data of the motor, may generate a first initial performance point based on the obtained first current data and the obtained first speed data, and may generate a second initial performance point based on the obtained first voltage data and the obtained first speed data.

The fan control apparatus of the vehicle may set a first boundary area based on position information of the first initial performance point on a first performance map and may set a second boundary area based on position information of the second initial performance point on a second performance map.

The fan control apparatus of the vehicle, in response to operation of the fan at a present time, may obtain second voltage data and second speed data of the motor. The fan control apparatus may also generate a first present performance point based on the obtained second current data and the obtained second speed data and may generate a second present performance point based on the obtained second voltage data and the obtained second speed data. In response to mapping the first present performance point to the first performance map, the fan control apparatus may also determine that the performance of the fan is changed when the first present performance point being located outside the first boundary area of the first performance map. In response to mapping the second present performance point to the second performance map, the fan control apparatus may also determine that the performance of the fan is changed when the second present performance point being located outside the second boundary area of the second performance map.

The communication device of the vehicle communicates with a server. The fan control apparatus of the vehicle may determine a direction of the positional change of the first present performance point corresponding to the positional change of the first present performance point and may determine a direction of the positional change of the second present performance point corresponding to the positional change of the second present performance point. The fan control apparatus may also determine a cause of a decrease in performance of the fan corresponding to the direction of the positional change of the first present performance point and the direction of the positional change of the second present performance point based on big data received by the server.

The fan control apparatus of the vehicle, based on a determination that the performance of the fan is decreased, may obtain a first optimization performance point based on position information of the first initial performance point and may obtain a second optimization performance point based on position information of the second initial performance point. The fan control apparatus may also update software for controlling the fan based on the first optimization performance point and the second optimization performance point. The fan control apparatus of the vehicle may change an operation point of the motor through the update of the software.

The fan control apparatus of the vehicle, when determining whether the performance of the fan is decreased, may identify use information and region information of the air conditioner and may determine whether the performance of the fan is decreased based on the identified use information and the identified region information of the air conditioner.

The memory of the vehicle may store fault diagnosis source code and fault response source code. The fan control apparatus of the vehicle may determine a fault based of the fault diagnosis source code stored in the memory and may control a fault response based on the fault response source code stored in the memory based on a determination of the fault.

The vehicle may further include a display device. The fan control apparatus of the vehicle may control the display device to display a fault code and a confirmation message for responding to the fault based on the determination of the fault.

### BRIEF DESCRIPTION OF THE DRAWINGS

These and/or other aspects of the disclosure should become apparent and more readily appreciated from the following description of the embodiments, taken in conjunction with the accompanying drawings, in which:

FIG. 1 is a view illustrating a control block diagram of a vehicle according to an embodiment of the disclosure;

FIGS. 2 and 3 are views illustrating an air conditioner of a vehicle according to an embodiment of the disclosure;

FIG. 4 is a view illustrating an inverter of a vehicle according to an embodiment of the disclosure;

FIGS. 5 and 6 are views illustrating first and second performance maps of a fan control apparatus of a vehicle an embodiment of the disclosure;

FIG. 7 is a view illustrating a boundary area mapped to the second performance map shown in FIG. 6;

FIG. 8 is a view illustrating determination of performance degradation through the second performance map shown in FIG. 6;

FIG. 9A is a view illustrating an example of obtaining a first optimal performance point for changing a driving point of a motor through the first performance map shown in FIG. 5;

FIG. 9B is a view illustrating an example of obtaining a second optimal performance point for changing a driving point of a motor through the second performance map shown in FIG. 6;

FIG. 10 is a view illustrating a graph of voltage and current corresponding to time when the current is controlled so that a phase angle of the voltage and a phase angle of the current is 28 degrees in a state where the driving point of the motor is not changed; and

FIG. 11 is a view illustrating a graph of voltage and current corresponding to time when the current is controlled so that a phase angle of the voltage and a phase angle of the current are 15 degrees.

### DETAILED DESCRIPTION

Reference is now made in detail to the embodiments of the disclosure, examples of which are illustrated in the accompanying drawings, wherein like reference numerals refer to like elements throughout. This specification does not describe all elements of the disclosed embodiments. Detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘parts’, ‘modules’, ‘members’, ‘blocks’ and the like may be embodied as one component. It is also possible that one ‘part’, ‘module’, ‘member’, ‘block’ and the like includes a plurality of components.

Throughout the specification, when an element is referred to as being “connected to” another element, the element may be directly or indirectly connected to the other element. Also, “indirectly connected to” includes being connected to the other element via a wireless communication network.

Also, it is to be understood that the terms “include” and “have” and variations thereof are intended to indicate the existence of elements disclosed in the specification and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the components are not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated. When a component, device, element, or the like of the present disclosure is described as having a purpose or performing an operation, function, or the like, the component, device, or element should be considered herein as being “configured to” meet that purpose of perform that operation or function.

Hereinafter, embodiments of the disclosure are described in detail with reference to the accompanying drawings.

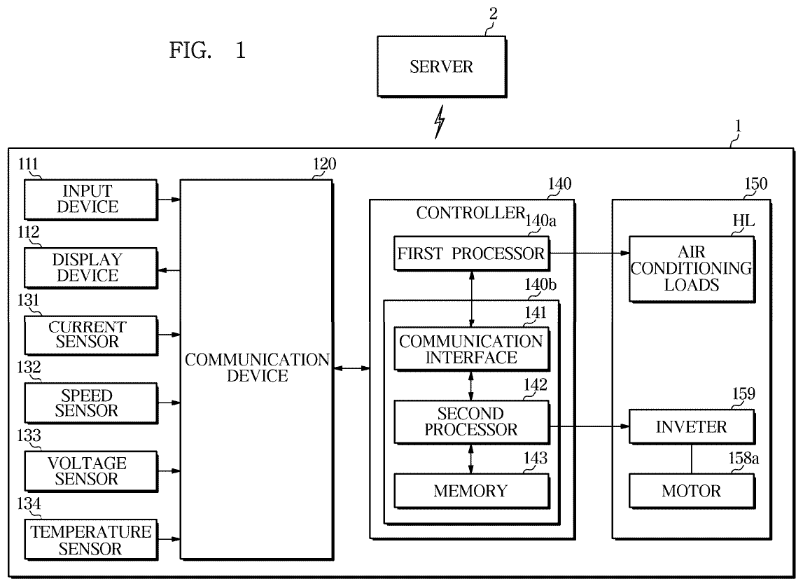

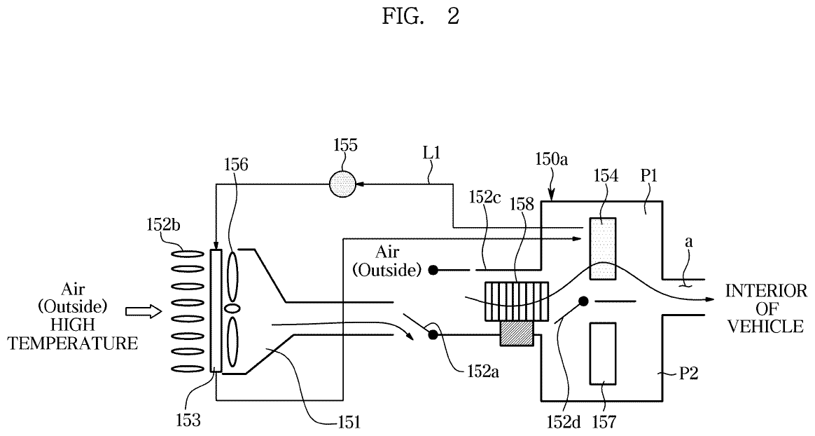

FIG. 1 is a view illustrating a control block diagram of a vehicle according to an embodiment and is described with reference to FIGS. 2-4.

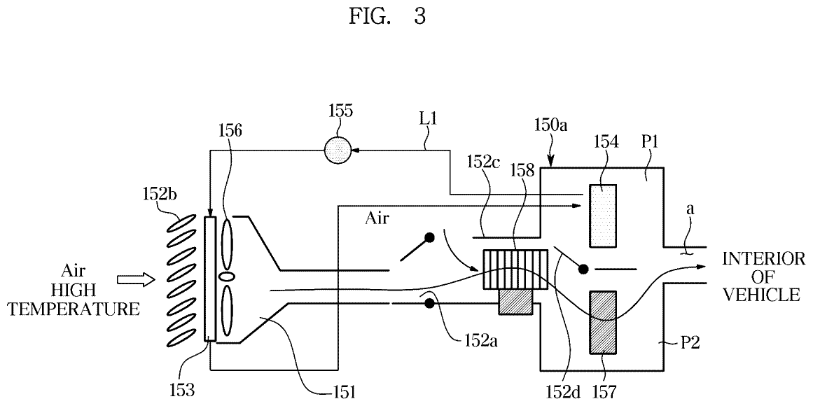

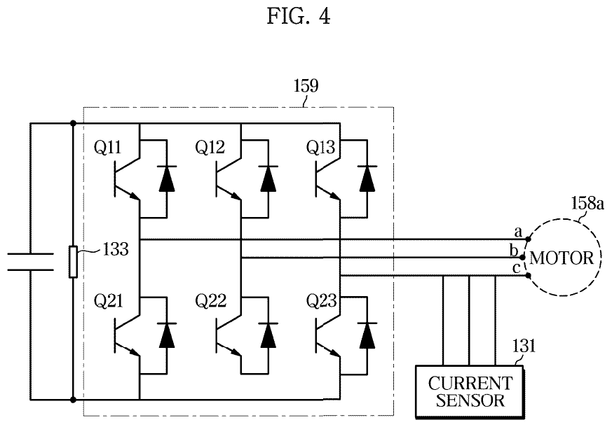

FIGS. 2 and 3 are views illustrating an air conditioner of the vehicle according to an embodiment. FIG. 4 is a view illustrating an inverter of the vehicle according to an embodiment.

The vehicle 1 includes an input device 111, a display device 112, a current sensor 131, a speed sensor 132, a voltage sensor 133, a temperature sensor 134, a communication device 120, a controller 140, and an air conditioner 150.

The input device 111 receives a user input.

The input device 111 may receive a user input to control operation of the air conditioner.

The user input to control the operation of the air conditioner may include a cooling mode, a heating mode, an indoor target temperature, a wind or airflow direction, an air volume, an outside air circulation mode, an inside air circulation mode, a defrost mode of a front windshield glass, and/or a defrost mode of a rear windshield glass.

The input device 111 may include hardware devices such as various buttons or switches, a pedal, a keyboard, a mouse, a track-ball, various levers, a handle, a stick, and/or the like.

The input device 111 may also include a graphical user interface (GUI) such as a touchpad, i.e., a software device. The touchpad may be implemented as a touch screen panel (TSP) and form a mutual layer structure with the display device 112.

When provided as the touch screen panel (TSP) forming a mutual layer structure with the touchpad, the display device 112 may also be used as the input device 111.

The input device 111 may be provided in a head unit of the vehicle.

The input device 111 may also be provided in a terminal device of the vehicle.

The terminal device is installed on a dashboard in a reclaimed or deferred manner, and the terminal device may be an audio, visual, and navigation (AVN) device that performs an audio function, a video function, and a navigation function. The terminal device may further perform at least one of a broadcast function (i.e., Digital Multimedia Broadcasting (DMB) function), a radio function, a content reproduction function, and/or an internet search function.

The display device 112 displays operation information about functions being performed in the vehicle.

For example, the display device 112 may display information related to a phone call, display content information output through the terminal device, display information related to music playback, and display broadcasting information of an external device.

The display device 112 may display a route from a current location of the vehicle to a destination and display road guidance information when performing a navigation mode.

The display device 112 may display operation information of the air conditioner 150.

The operation information of the air conditioner 150 may include information about a mode being performed (e.g., a performance mode), the interior or inside target temperature, the wind or airflow direction, and the air volume.

Modes that may be performed by the air conditioner may include the cooling mode, the heating mode, the outside air circulation mode, the inside air circulation mode, the defrost mode of the front windshield glass, and the defrost mode of the rear windshield glass.

The display device 112 can also display fault information of the fan control apparatus 140b and a confirmation message for handling the fault.

The display device 112 may also display a message guiding or instructing a visit to a service center in response to the fault of the fan control apparatus 140b.

The display device 112 may be provided on the head unit of the vehicle or may be provided on an instrument cluster.

The display device 112 may also be provided in the terminal device of the vehicle.

The display device 112 may be provided as a cathode ray tube (CRT), a digital light processing (DLP) panel, a plasma display panel (PDP), liquid crystal display (LCD) panel, electro luminescence (EL) panel, electrophoretic display (EPD) panel, electrochromic display (ECD) panel, light emitting diode (LED) panel, organic LED (OLED) panel, and/or the like, without being limited thereto.

The communication device 120 may include one or more communication modules enabling communication between components within the vehicle and between the vehicle and an external device. For example, one or more the communication modules include at least one of a short-range communication module, wireless communication module, or a wired communication module.

The short-range communication module may include a variety of short-range communication modules that transmit and receive signals in a short distance using a wireless communication network, such as a Bluetooth module, infrared communication module, radio frequency identification (RFID) communication module, wireless local access network (WLAN) communication module, near-field communication (NFC) communication module, Zigbee communication module, or the like.

The wired communication module may include various wired communication modules such as a controller area network (CAN) communication module, local area network (LAN) module, wide area network (WAN) module, value added network (VAN) module, or the like, and also include various cable communication modules such as a universal serial bus (USB), high definition multimedia interface (HDMI), digital visual interface (DVI), recommended standard 232 (RS-232), power line communication, plain old telephone service (POTS), or the like.

The wired communication module may further include a Local Interconnect Network (LIN).

The wireless communication module may include wireless communication modules that support a variety of wireless communication methods such as a global system for mobile communication (GSM), code division multiple access (CDMA), wideband CDMA (WCDMA), universal mobile telecommunications system (UMTS), time division multiple access (TDMA), long term evolution (LTE), or the like, in addition to a Wifi module and a Wibro module.

The communication device 120 may perform transmission and reception of information between the input device 111 and the controller 140, perform transmission and reception of information between the display device 112 and the controller 140, and perform transmission and reception of information between various sensors 131, 132, 133, 134 and the controller 140.

The communication device 120 may perform transmission and reception of information between the controller 140 and various loads of the air conditioner 150.

The communication device 120 may perform transmission and reception of information between the controller 140 and a server 2.

The server 2 may be a server provided in a manufacturing center, a maintenance center, or a service center that manages the vehicle 1. In addition, the server 2 may be an application (i.e., app) server that provides a service associated with the vehicle 1 and may be a telematics server or a platform server.

The server 2 may collect big data and transmit the collected big data to the vehicle 1. In some examples, the big data may be crowd sourced from a plurality of users.

The big data may include reference data for determining performance degradation of the fan control apparatus 140b, a reference level of performance, and use information.

The big data may include reference data for determining performance degradation of the fan control apparatus 140b for each type of vehicle, a reference level of performance for each type of vehicle, and use information for each type of vehicle.

The big data may include performance degradation information corresponding to performance parameters of the motor and the use information.

The use information may include use time information, use mode information, and use region information.

The big data may include information on an optimal performance point for improving efficiency of the fan control apparatus 140b.

The big data may include performance calibration information for improving efficiency of the battery.

The big data may include fault diagnosis source code for fault diagnosis and fault response source code for fault response.

The big data may include confirmation message information to be confirmed for each phenomenon caused by the diagnosed fault.

The server 2 may store identification information of the vehicle 1 and identification information of the user.

The identification information of the vehicle 1 may include vehicle type, vehicle model, license plate information, power generation method (e.g., hybrid, electric, engine, hydrogen, etc.) and gear shift method of the vehicle.

The identification information of the user may include the user's name, the user's home address, the user's e-mail address, the user's social security number, date of birth, identification information of the user's mobile device, and driver's license information of the user.

The current sensor 131 detects a current flowing in the motor 158a provided in the fan 158 of the air conditioner 150 (see FIG. 2).

The speed sensor 132 detects a rotational speed of the motor 158a of the fan. The speed sensor 132 may include at least one of a position sensor, a hall sensor, and a resolver.

The voltage sensor 133 detects a voltage applied to the motor 158a of the fan. A voltage sensor may detect the DC link voltage.

The temperature sensor 134 detects an outside temperature of the vehicle 1 (i.e., an outside air temperature).

The vehicle 1 may further include a battery (not shown) for supplying driving power to various electronic devices provided in the vehicle, and a battery management device (not shown) for monitoring a charging state of the battery.

The various electronic devices include the head unit, the air conditioner (150), an outdoor lamp (e.g., exterior light), an interior lamp (e.g., interior light), the input device (111), the display device (112), the cluster, a camera, a black box, a lidar sensor, a radar sensor, an ultrasonic sensor, the various sensors, speakers, and the like.

The battery may be a battery capable of being charged and discharged.

If the vehicle is powered by the engine, the vehicle may include a battery for supplying power to the various electronic devices.

If the vehicle is an eco-friendly vehicle, the vehicle may include a high voltage battery for supplying power to a driving motor connected to wheels, and a low voltage battery for supplying power to the various electronic devices.

The controller 140 may control the operation of the air conditioner 150 in response to the user input.

The controller 140 may automatically adjust an interior temperature of the vehicle based on an interior temperature detected by an interior air temperature sensor, an outdoor air temperature detected by an outdoor air temperature sensor, and an evaporator temperature detected by an evaporator temperature sensor when an ON command of an automatic air conditioning mode is received through the input device 111. This controller 140 is described later.

The air conditioner 150 controls an air temperature inside the vehicle by sucking in or drawing air from outside the vehicle and supplying cool or warm air to the inside of the vehicle by exchanging heat with the intake air in response to a control command of the controller 140.

An example of the structure of the air conditioner 150 is described with reference to FIGS. 2 and 3.

FIGS. 2 and 3 illustrate an air conditioner of the vehicle according to an embodiment. FIG. 2 illustrates an example of an operation of the air conditioner in the cooling mode and FIG. 3 illustrates an example of an operation of the air conditioner in the heating mode.

The air conditioner 150 includes a duct 151 provided on a front side of the vehicle to allow air to pass through a rear side of the duct 151 and includes a first damper 152a provided on the rear side of the duct 151 configured to open or close the duct 151. The air conditioner 150 includes a condenser 153 configured to change a high-temperature, high-pressure vapor refrigerant generated in a compressor 155 into a liquid refrigerant by condensing the high-temperature, high-pressure vapor refrigerant generated in the compressor 155. The air conditioner 150 further includes an evaporator 154 provided in a cooling passage p1 inside the air conditioner and configured to cool a temperature of air by absorbing heat from surroundings while vaporizing the refrigerant with reduced density and pressure. The air conditioner also includes a compressor 155 configured to compress the refrigerant passing through the evaporator 154 into the high-temperature, high-pressure vapor refrigerant, and a fan 158 configured to blow the air heat-exchanged in the evaporator 154 into the interior the vehicle.

The fan 158 is also referred to as a blower or a blowing device.

The condenser 153 may be a radiator. In addition, a second damper 152b may be provided on a front side of the condenser 153, configured to open the duct 151.

The duct 151 may be coupled to a rear side of the condenser 153. The duct 151 allowing air to pass through to the air conditioner 150.

When the second damper 152b is opened, outside air may flow into the duct 151 adjacent to the rear side of the condenser 153. When the second damper 152b is partially or entirely closed, a flow of the outside air into the duct 151 may be partially or completely blocked.

A cooling fan 156 to configured to cool the condenser 153 may be provided at the rear side of the condenser 153.

When the first damper 152a is opened, the air on the rear side of the condenser 110 may be discharged to the outdoors, and when the first damper 152a is closed, the air may be flow into the interior of the vehicle through the duct 151 and the fan 158.

A third damper 152c may be provided on one side of the fan 158 and be configured to selectively flow in or intake inside air or outside air according to the outside air circulation mode or the inside air circulation mode of the air conditioner 150.

The third damper 152c may be provided above the rear side of the duct 151 and a front side of the fan 158 of the air conditioner 150. When the third damper 152c is opened, the outside air circulation mode in which the outside air flows into the air conditioner 150 may be performed. In addition, when the third damper 152c is closed, an inflow of air from the outside to the air conditioner 150 is blocked and the inside air circulation mode in which indoor air flows into the air conditioner 150 may be performed.

The air conditioner 150 may further include a heating passage p2 provided with a heater 157 separately from the cooling passage p1. The air flowing into the heating passage p2 may be heated by the heater 157 and supplied to the interior of the vehicle.

The heater 157 may be a Positive Temperature Coefficient heater (PTC heater).

The air conditioner 150 may further include a fourth damper 152d provided on a rear side of the fan 158.

The air blown through the fan 158 according to the cooling mode or heating mode selected by the user is transferred to either the cooling passage p1 or the heating passage p2 by the fourth damper 152d.

In other words, cool air or warm air may be blown into the interior of the vehicle through the fourth damper 152d and the fan 158.

In addition, the air conditioner 150 may further include an outlet ‘a’. The outlet ‘a’ allows cooled or heated air to be discharged into the interior of the vehicle through the cooling passage p1 or the heating passage p2.

The condenser 153, the evaporator 154, and the compressor 155 of the embodiment may be connected through one refrigerant line L1.

An expansion valve, a pressure reducing valve, or a capillary tube may be further provided between the condenser 153 and the evaporator 154.

The expansion valve or capillary tube is a device that reduces the high-temperature, high-pressure refrigerant liquefied in the condenser to a pressure capable of causing evaporation by a throttling action.

The condenser 153, expansion valve, evaporator 154 and compressor 155 may be a closed circuit.

Accordingly, the circulation of the refrigerant in the refrigerant line L1 in FIGS. 2 and 3 is the same.

Looking at the flow of the refrigerant in the refrigerant line (L1), the refrigerant that has exchanged heat with air in the evaporator 154 of the cooling passage p1 of the air conditioner 150 flows into the condenser 153 via the compressor 155 along the refrigerant line L1. The refrigerant condensed in the condenser 153 flows into the evaporator 154 of the cooling passage p1 of the air conditioner 150. The refrigerant continues to circulate as described above.

The air conditioner 150 opens the second damper 152b to dissipate heat from the condenser 153. The opening and closing of the second damper 152b may be adjusted step by step (e.g., gradually, iteratively) so that the condenser 153 can dissipate heat as needed.

As shown in FIG. 2, in the cooling mode, the temperature of the air outside the vehicle is relatively high compared to the temperature of the air inside the vehicle. However, the air collected in the rear side of the duct 151 adjacent to the condenser 153 forms a relatively higher temperature than the outside air. Accordingly, the air conditioner 150 may open the first damper 152a of the duct 151 to discharge relatively high temperature air to the outside. The air conditioner 150 may also allow the outside air to flow by opening the third damper 152c. At this time, the fourth damper 152d in the air conditioner 150 is opened toward the cooling passage p1 so that the outside air may be cooled more quickly and easily through the evaporator 154 of the cooling passage p1. At this time, the air cooled through the evaporator 154 may be discharged into the interior of the vehicle through the outlet ‘a’. In this case, the heater 157 of the heating passage p2 formed separately from the cooling passage p1 is not driven.

As shown in FIG. 3, in the heating mode, the temperature of the air outside the vehicle is relatively low compared to the temperature of the air inside the vehicle. In addition, the temperature of the air collected in the rear side of the duct 151 adjacent to the condenser 153 is elevated due to heat exchange with the refrigerant. Accordingly, the air conditioner 150 closes the first damper 152a of the duct 151 so that the high-temperature air of the duct 151 flows into the air conditioner 150. The air conditioner 150 closes the third damper 152c so that the inside air having a relatively high temperature compared to the outside air is blown into the interior of the vehicle through the fan 158.

At this time, the fourth damper 152d of the air conditioner 150 is opened to the heating passage p2.

The warm air of the duct 151 and the warm air of the interior of the vehicle flowing through the fourth damper 152d may be heated more quickly and easily through the heater 157 of the heating passage p2 and discharged into the interior of the vehicle through the outlet ‘a’.

The air conditioner 150 shown in FIGS. 2 and 3 is only an example of the air conditioner provided in the vehicle, and the structure of the air conditioner is not limited thereto.

As shown in FIG. 4, the air conditioner 150 may include a motor 158a configured to rotate the fan 158 and an inverter 159 configured to drive the motor 158a and may further include a smoothing device. Here, the inverter 159 and the motor 158a may be integrally provided with the fan control apparatus 140b.

The smoothing device may include at least one capacitor and smooths a current input through a battery (not shown) or a power converter (not shown) in order to lower a pulsating current.

The inverter 159 drives the motor 158a based on a control signal of a second processor 142. In other words, the inverter 159 generates current for driving the motor 158a according to the control signal of the second processor 142.

The inverter 159 may include a plurality of switching elements Q11, Q12, Q13, Q21, Q22, and Q23 that convert DC power transferred from the smoothing device into three-phase AC power.

For example, the plurality of switching elements may include three upper switching elements Q11, Q12, and Q13 and three lower switching elements Q21, Q22, and Q23. Here, each of the three upper switching elements Q11, Q12, and Q13 and each of the three lower switching elements Q21, Q22, and Q23 may be connected in series. In other words, a first upper switching element Q11 is connected in series with a first lower switching element Q21 on a terminal a, and a second upper switching element Q12 is connected in series with a second lower switching element Q22 on a terminal b, and a third upper switching element Q31 may be connected in series with a third lower switching element Q32 on a c terminal.

Three nodes to which the three upper switching elements Q11, Q12, and Q13 and the three lower switching elements Q21, Q22, and Q23 are respectively connected are respectively connected to three input terminals of the motor 158a. At this time, a current generated by the plurality of switching elements Q11, Q12, Q13, Q21, Q22, and Q23 may be supplied to the motor 158a through the three input terminals.

The plurality of switching elements Q11, Q12, Q13, Q21, Q22, and Q23 of the inverter 159 may be turned on or off based on a control signal (i.e., a pulse width modulation or PWM signal) output from the first processor 140a.

The inverter 159 converts a voltage of the battery (not shown) into a voltage for driving the fan 158 of the air conditioner, converts the DC voltage into AC voltage in response to the converted voltage, and converts the converted AC voltage into the motor 158a.

In other words, the inverter 159 may convert power for the battery into power for driving the motor 158a.

A current sensor 131 configured to detect a current flowing in the motor 158a may be provided at the three input terminals of the motor 158a.

The current sensor 131 may detect a current applied to the motor 158a through at least one input terminal among the three-phase input terminals of the motor 158a and output a signal corresponding to the detected current.

A voltage sensor 133 configured to detect a voltage flowing through the motor 158a may be provided at both ends of the smoothing device. In other words, the voltage sensor 133 may detect a DC voltage at both ends of the DC voltage and output a signal corresponding to the detected voltage.

A position sensor configured to detect a position of a rotor may be provided in the motor 158a. Here, the position of the rotor may be an angle of the rotor.

The position sensor may be a resolver, a Hall sensor, or a speed sensor for detecting the rotational speed of the motor.

The controller 140 controls at least one of the compressor 155, the expansion valve, a cooling water valve, the fan 158, and the cooling fan 156 based on signals detected by various sensors to perform at least one of the inside air circulation mode, the outside air circulation mode, and the cooling mode and the heating mode, and to adjust the air volume, the indoor temperature, and the wind direction.

The controller 140 may transmit current location information of the vehicle to the server 2 and may receive weather information and fine dust information from the server 2. The controller 140 may also receive outside temperature information from the server 2.

As shown in FIG. 1, the controller 140 includes the first processor 140a for controlling air conditioning loads HL and the fan control apparatus 140b for monitoring and controlling the motor 158a.

The air conditioning load HL may be a load other than the motor 158a and the inverter 159 among loads provided in the air conditioner 150. The air conditioning load HL includes loads from the cooling water valve, the expansion valve, the compressor 155, the cooling fan 156, and the first, second, third, and fourth dampers 152a, 152b, 152c, and 152d and the heater 157.

The first processor 140a may control the operation of the air conditioning load HL based on the user input received by the input device 111.

The first processor 140a may communicate with the fan control apparatus 140b for controlling the fan 158 to transmit and receive various data and information with the fan control apparatus 140b.

The performance of the motor 158a provided in the fan 158 or the second processor 142 for controlling the motor 158a may deteriorate as the period of use or the number of times of use of the air conditioner 150 increases. Also, the performance of the second processor 142 may vary depending on the region where the vehicle mainly travels.

Accordingly, the fan control apparatus 140b controls the operation of the motor 158a of the fan 158 and performs monitoring to identify states of the motor 158a of the fan 158 and the second processor 142. Additionally, the fan control apparatus 140b performs fault diagnosis.

The fan control apparatus 140b may include a communication interface 141, a second processor 142, and a memory 143. The fan control apparatus 140b may be integrally provided with the motor 158a.

The communication interface 141 may communicate with the current sensor 131, the voltage sensor 133, and the speed sensor 132 connected to the motor 158a. The communication interface 141 may communicate with the temperature sensor 134 and the input device 111 and may perform communication with the battery management device (not shown).

Here, the speed sensor may be a position sensor that detects the position of the rotor of the motor 158a.

The communication interface 141 may communicate with the first processor 140a. For example, the communication interface 141 may use LIN communication or may use CAN.

The second processor 142 may obtain the rotational speed of the motor based on the angle of the rotor of the motor detected by the position sensor.

The second processor 142 compares a target speed (or a speed command) received by the input device 111 with the obtained rotational speed of the motor and obtains a target current according to the comparison result.

The second processor 142 compares the obtained target current with the current detected by the current sensor 131 and obtains a target voltage according to the comparison result.

In other words, the second processor 142 converts a, b, and c-phase currents detected by the current sensor 131 into a d-axis current and a q-axis current based on the angle of the rotor of the motor 158a.

The second processor 142 may include a proportional controller ‘P’, a proportional integral controller ‘PI’, or a proportional integral derivative controller ‘PID’.

The second processor 142 compares a q-axis target current and the converted q-axis current of the motor, and obtains a q-axis target voltage according to the comparison result. The second processor 142 obtains a d-axis target current based on the obtained rotational speed of the motor 158a and the detected angle of the rotor, compares the d-axis target current and the converted d-axis current of the motor, and obtains a d-axis target current according to the comparison result.

The second processor 142 converts the d-axis target voltage and the q-axis target voltage to a, b, and c-phase target voltages of the motor 158a based on the angle of the rotor of the motor.

The second processor 142 generates a control signal variable pulse width modulation (VPWM) to be provided to the inverter 159 based on the target voltages of phases a, b, and c.

Specifically, the second processor 142 outputs the control signal for turning on or off the plurality of switching elements of the inverter 159 by pulse width modulation (PWM) on each of the a, b, and c-phase target voltages.

The second processor 142 adjusts the current applied to the motor 158a by controlling the on and off of the plurality of switching elements of the inverter 159.

The second processor 142 controls a rotation speed of the motor 158a at a speed corresponding to the adjusted current by adjusting the current applied to the motor 158a.

The second processor 142 may collect operation information of the motor when controlling the motor 158a.

The second processor 142 may also collect operation information of the motor corresponding to the use information of the air conditioner 150.

The second processor 142 collects a current signal of the current sensor 131, a speed signal of the speed sensor 132, a voltage signal of the voltage sensor 133, and an outside temperature signal of the temperature sensor 134 as the operation information of the motor.

The second processor 142 converts signals from various sensors provided in the air conditioner into digital signals, obtains sensor data based on the converted digital signals, and collects the obtained sensor data as performance parameters of the motor.

The second processor 142 may generate first and second performance maps using the performance parameters of the motor and transmit the generated first and second performance maps to the server 2.

The first performance map may include current data, voltage data, and speed data.

The second performance map may include efficiency data, voltage data, and speed data.

The first and second performance maps transmitted to the server 2 may be used for personalized service, performance calibration and fault response information, durability evaluation, and lifespan determination of the fan control apparatus.

The second processor 142 may transmit temperature data to the server 2 and may further transmit information on efficiency of the fan control apparatus, deterioration of the fan control apparatus, and use of the air conditioner to the server 2.

The second processor 142 obtains reference data from the big data and obtains a reference performance curve map based on the obtained reference data.

The reference data is data obtained when the performance of the fan control apparatus is at its maximum, and may include voltage data, speed data, torque data, current data, and efficiency data.

The reference data is data obtained when the fan control apparatus is initially operated, and may include voltage data, speed data, torque data, current data, and efficiency data.

The second processor 142 maps the performance parameters of the motor to performance points on the reference performance curve map.

The performance point is a performance point obtained when the motor is initially controlled through the fan control apparatus and may be an initial performance point.

The second processor 142 may generate a second initial performance point at a position where voltage data of the motor detected by the voltage sensor, speed data of the motor detected by the speed sensor, and torque data of the motor detected by the torque sensor (not shown) matches among positions of the first reference performance curve map.

The second processor 142 may generate a first initial performance point at a position where current data of the motor detected by the current sensor, speed data of the motor detected by the speed sensor, and torque data of the motor detected by a torque sensor (not shown) matches among positions of the second reference performance curve map.

The torque of the motor can be obtained by power (i.e., power) and angular velocity of the motor.

The torque of the motor can be obtained by a torque constant and the current of the motor.

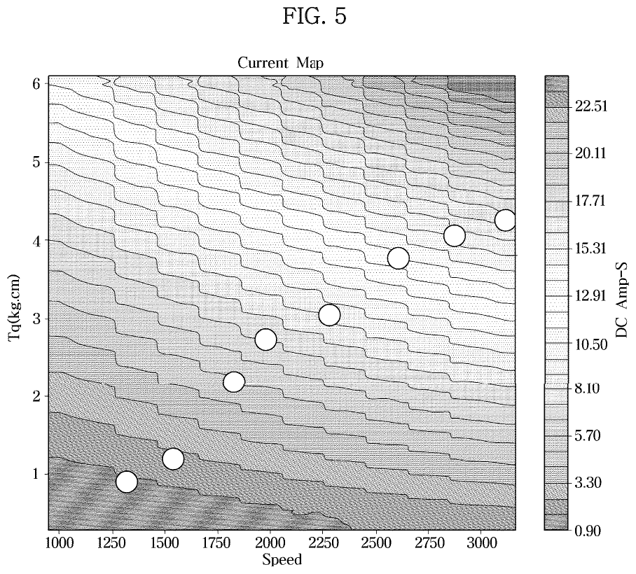

As shown in FIG. 5, the second processor 142 obtains a first performance map in which the first initial performance point is mapped to the first reference performance curve map based on correlation between the speed data, the torque data, and the current data of the motor

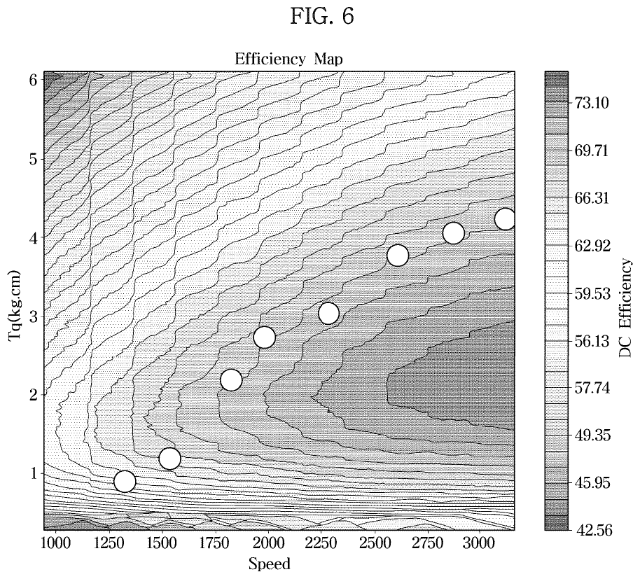

As shown in FIG. 6, the second processor 142 obtains a second performance map in which the second initial performance point is mapped to the second reference performance curve map based on correlation between the speed data, the torque data, and the efficiency data of the motor.

The second processor 142 may identify a variability of performance based on the first initial performance point mapped to the first reference performance curve map and the second initial performance point mapped to the second reference performance curve map.

More specifically, a configuration for identifying the variability of performance is described.

The second processor 142 sets a first boundary area for the current applied to the motor 158a based on position information of the first initial performance point.

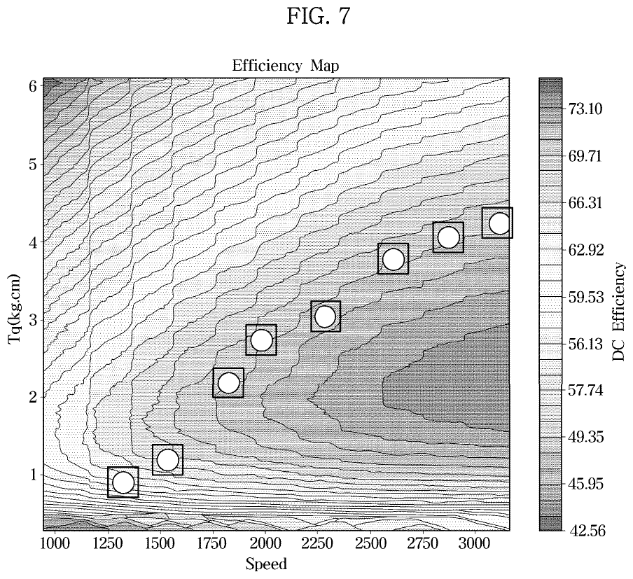

As shown in FIG. 7, the second processor 142 may set a second boundary area for the efficiency of the motor 158a based on position information of the second initial performance point.

The first and second boundary areas are reference areas satisfying a hardware performance of the fan control apparatus 140b and the performance of the motor 158a and may be areas having a predetermined size.

Here, the predetermined size may be information obtained and stored through a test.

The size of the first boundary area and the size of the second boundary area may be the same or different.

The second processor 142 identifies a first present performance point mapped to the first reference performance curve map during the operation of the fan 158. The second processor 142 also determines a positional change of the first present performance point based on a position of the first initial performance point by comparing position information of the first present performance point and position information of the first initial performance point. The second processor 142 identifies a second present performance point mapped to the second reference performance curve map during the operation of the fan 158. The second processor 142 also determines a positional change of the second present performance point based on a position of the second initial performance point by comparing position information of the second present performance point and position information of the second initial performance point.

As another example, the second processor 142 primarily identifies the first performance point mapped to the first reference performance curve map at a first time point during the operation of the fan 158 and, when a preset time elapses from the first time point, secondly identifies the first performance point mapped to the first reference performance curve map at a second time point. The second processor 142 also compares position information of the firstly identified first performance point and position information of the secondly identified first performance point and determines a positional change of the secondly confirmed first performance point based on a position of the firstly identified first performance according to the comparison.

The second processor 142 primarily identifies the second performance point mapped to the second reference performance curve map at a first time point during the operation of the fan 158 and, when a preset time elapses from the first time point, secondly identifies the second performance point mapped to the second reference performance curve map at a second time point. The second processor 142 also compares position information of the firstly identified second performance point and position information of the secondly identified second performance point and determines a positional change of the secondly confirmed second performance point based on a position of the firstly identified second performance according to the comparison.

Here, the primarily or firstly identified first and second performance points may be past first and second performance points and the secondly identified first and second performance points may be present first and second performance points.

The second processor 142 may identify a variability of performance based on the positional change of the first present performance point and the positional change of the present second performance point.

The positional change of the first and second present performance points may include a direction in which the first present performance point changes and a direction in which the second present performance point changes.

The positional change of the first and second present performance points may further include a change amount of the first present performance point and a change amount of the second present performance point.

The second processor 142 determines at least one of performance degradation due to durability (e.g., deterioration, wear) of the fan control apparatus, performance degradation due to region temperature, performance degradation due to dust, performance degradation due to fan wheel eccentricity, performance degradation due to deterioration, and performance degradation due to control error based on the variability of performance.

The durability or deterioration of the fan control apparatus may include worsened hardware performance of the fan control apparatus 140b and performance of the motor 158a.

Information on a cause of the performance degradation corresponding to the variability of performance may be stored in advance. The information on the cause of the performance degradation corresponding to the variability of performance may be obtained from the big data.

The second processor 142 may determine that the performance is degraded when the first present performance point is located outside the first boundary area of the first performance map.

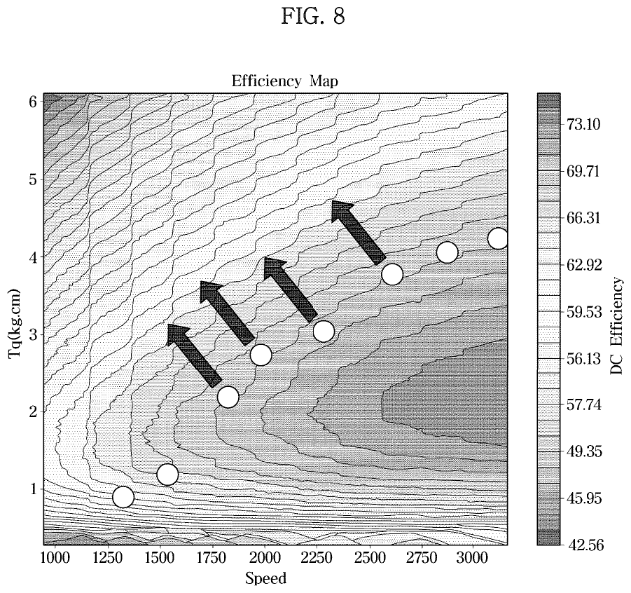

As shown in FIG. 8, the second processor 142 may determine that the performance is degraded when the second present performance point is located outside the second boundary area of the second performance map and changes in a direction of an arrow in FIG. 8.

In other words, the second processor 142 may determine that the performance of the fan control apparatus 140b and the motor 158a is reduced when the change in the first present performance point is determined as a decrease in speed of the motor and an increase in current of the motor.

In addition, the second processor 142 may determine that the performance of the fan control apparatus 140b and the motor 158a is reduced when the change in the second present performance point is determined as a decrease in speed of the motor and an increase in torque of the motor.

Based on the big data, the second processor 142 may identify the cause of performance degradation corresponding to a phenomenon in which the speed of the motor 158a decreases and the torque of the motor increases.

For example, the second processor 142 may identify at least one of the dust, the fan wheel eccentricity, the deterioration of the fan control apparatus, and the control error as the cause of performance degradation based on the big data.

The second processor 142 may calibrate the software based on the identified cause of the performance degradation. Here, the software calibration may be software update.

The second processor 142 may determine whether to provide the personalized service based on the identified cause of performance degradation.

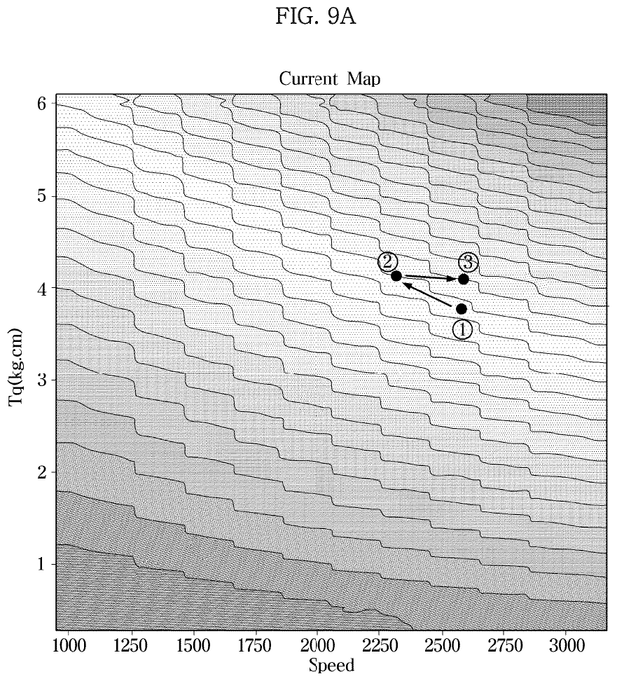

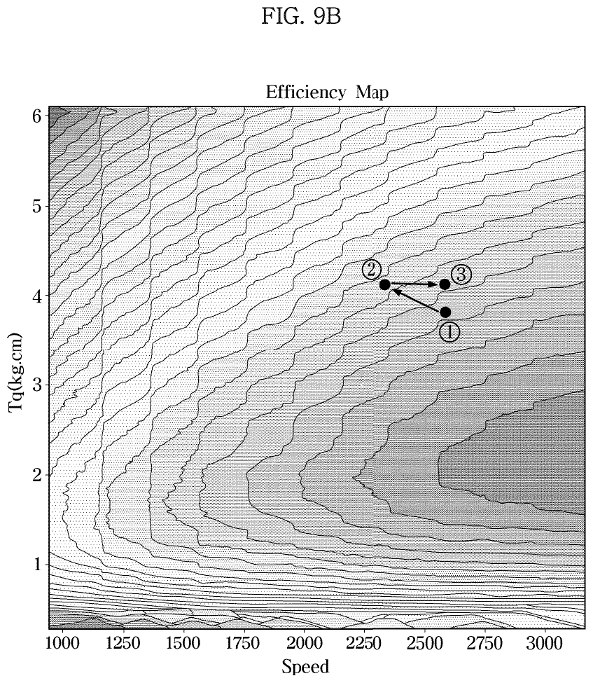

As shown in FIG. 9A, when it is determined that the performance is degraded by moving from a position of number 1 to a position of number 2, the second processor 142 identifies the current data corresponding to the first initial performance point, identifies the torque data corresponding to the first present performance point, obtains a first optimization performance point 3 corresponding to the identified torque data and the identified current data, and calibrates the software based on the obtained first optimization performance point.

The first optimization performance point may be a point of number 3 in FIG. 9A.

As shown in FIG. 9B, when it is determined that the performance is degraded by moving from a position of number 1 to a position of number 2, the second processor 142 identifies the efficiency data corresponding to the second initial performance point, identifies the torque data corresponding to the second present performance point, obtains a second optimization performance point 3 corresponding to the identified torque data and the identified efficiency data, and calibrates the software based on the obtained second optimization performance point.

The second optimization performance point may be a point of number 3 in FIG. 9B.

The second processor 142 may calibrate the software of the fan control apparatus 140b through OTA (Over The Air) when it is determined that the variability of performance is at least one of performance degradation due to the durability or deterioration of the fan control apparatus and performance degradation due to the region temperature.

When the software of the fan control apparatus 140b is calibrated, the second processor 142 obtains the first and second optimization performance points based on the big data received from the server 2 and calibrates the software of the fan control apparatus 140b based on the obtained first and second optimization performance points.

When it is determined that the performance is degraded, the second processor 142 diagnoses the failure using the fault diagnosis code source, when diagnosing the fault, the second processor 142 obtains the first and second performance maps and determines whether the performance is degraded based on the obtained first and second performance maps.

When it is determined that the performance is degraded, the second processor 142 may identify the phenomenon caused by the performance degradation, determine the failure corresponding to the identified phenomenon, obtain a fault code to solve the determined failure, and control the display of the obtained fault code.

In response to failure determination, the second processor 142 may determine a fault response source code corresponding to the determined failure and respond to the failure itself using the determined fault response source code.

When it is determined that the performance is degraded, the second processor 142 may control the display device 112 to display a fault confirmation message to respond to the phenomenon caused by the performance deterioration and control the display device 112 to display the phenomenon caused by the performance deterioration.

Examples of phenomena caused by performance degradation included in big data, fault codes, and fault confirmation messages for handling faults are as follows.

| | | Fault confirmation |
|---|---|---|
| Phenomena | Fault codes | messages |
| Resistance increase due to | Over current, Current | Check input current |
| device deterioration | Limit | increase and efficiency |
| | | decrease |
| occurrence of irreversible | Over current, Current | Comparison of |
| demagnetization | Limit | performance according to |
| | | odometer at the same |
| | | outdoor temperature, |
| | | Analysis of transient |
| | | section by motor inertia |
| | | moment by initial trip |
| load increase | Over current, Current Limit | Max Blower operating |
| | | point check, phase control |
| | | for current reduction and |
| | | air volume reduction |
| a large influx of dust | Over current, Locked Motor | Collection of high |
| | | temperature condition |
| | | data and low temperature |
| | | condition data of ambient |
| | | temperature (same date |
| | | and GPS) |
| Increase wheel eccentricity | Over current | Outside temperature: |
| | | room temperature, |
| | | Same condition data |
| | | collection (same date and |
| | | GPS), performance |
| | | comparison on similar |
| | | odometer vehicles |
| Input current fluctuation | Over Temperature, Limp | Analysis of device |
| | | performance deterioration |
| | mode | due to long-term parking |
| | | in summer and winter, |
| | | initial occurrence of |
| | | temperature limit range |

The second processor 142 obtains the first and second optimization performance points for efficiency improvement when it is determined that the position of the first present performance point is located within the first boundary area and is located on a boundary line of the first boundary area. The second processor 142 then updates the software based on the obtained the first and second optimization performance points. At this time, the second processor 142 may also transmit the obtained first and second optimization performance points to the server 2.

The second processor 142 identifies the same or similar phenomena as those occurring in the fan control apparatus 140b and the motor 158a based on the big data and obtains performance improvement information and thermal design power (TDP) calibration information based on the identified same or similar phenomena.

The second processor 142 controls the fault response based on the fault response source code. When the performance of the fan control apparatus 140b and the motor 158a improves according to the fault response, the second processor 142 transmits information used for performance improvement to the server 2. Here, the information used for performance improvement may include the performance parameters of the motor 158a, same or similar phenomenon information, and performance improvement information.

The second processor 142 may change the driving point of the motor 158a by controlling a phase angle of the current based on the first and second optimization performance points.

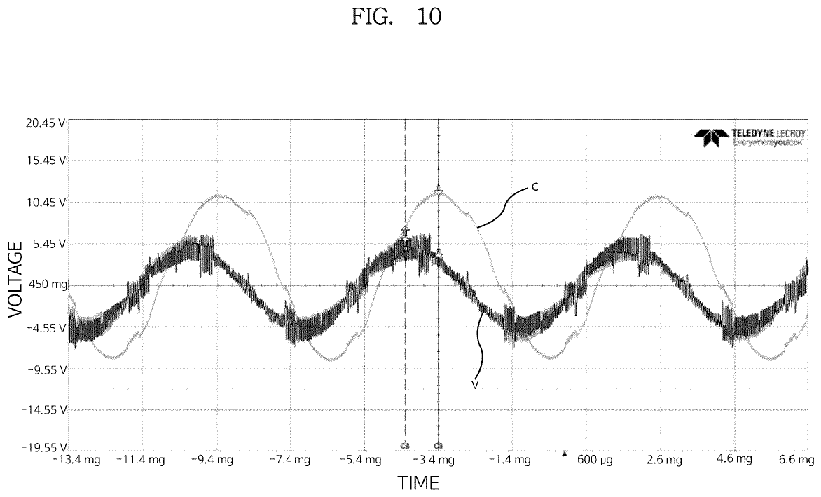

FIG. 10 is a graph of voltage V and current C over time in a state in which the driving point of the motor 158a is not changed, the rotational speed (RPM) of the motor 158a is 2030 rpm, the torque is 0.16 Nm, and the phase angle of the voltage and current is 28 degrees.

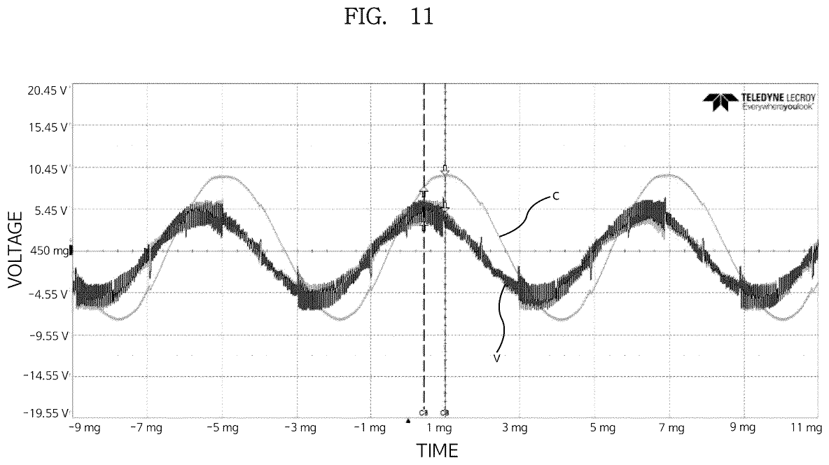

FIG. 11 is a graph of voltage V and current C over time in a state in which the driving point of the motor 158a is changed, the rotational speed (RPM) of the motor 158a is 2030 rpm, the torque is 0.16 Nm, and the phase angle between voltage and current is 15 degrees.

When comparing the efficiencies in FIGS. 10 and 11, it may be seen that the efficiency is improved from 77.8% to 84.8%, approximately 7%, by changing the driving point of the motor 158a.

The second processor 142 obtains the first and second performance maps when controlling the phase angle of the current based on the first and second optimization performance points. The second processor 142 also obtains performance improvement information based on the obtained first and second performance maps and controls the memory to store the obtained the performance improvement information.

The second processor 142 transmits the performance improvement information to the server 2. The second processor 142 may be used to improve performance through Over The Air (OTA) in other vehicles.

When it is determined that the performance is degraded, the second processor 142 determines a present performance level. When the determined present performance level is below a predetermined reference performance level or when the same failure occurs more than a predetermined number of times during a predetermined period, the second processor 142 provides the personalized service for each vehicle.

When providing the personalized service, the second processor 142 may display a message suggesting a visit to a service center through the display device 112.

The second processor 142 may store the use information of the air conditioner 150 received through the input device 111 and transmit the stored use information of the air conditioner 150 to the server 2.

The use information of the air conditioner may include use time information of the air conditioner, use mode information of the air conditioner, and use region information of the air conditioner.

The use mode information may include information on the most used mode among modes of the air conditioner.

The use mode information may include information on a mode used more than a preset number of times during a preset period among modes of the air conditioner.

The second processor 142 may collect performance improvement information of the air conditioner to improve battery efficiency.

The second processor 142 may analyze a use frequency based on the use information of the air conditioner.

The second processor 142 may determine the efficiency of the fan control apparatus based on the use frequency and the performance parameters of the motor.

The second processor 142 may identify a speed reduction of the motor compared to an input parameter among the performance parameters of the motor, evaluate the durability based on the identified speed reduction of the motor, and determine the lifespan of the fan control apparatus 140b.

The input parameter may include the speed data of the motor, the voltage data of the motor, and may further include outside temperature data and mileage data.

The second processor 142 may evaluate the durability and determine the lifespan of the fan control apparatus based on the efficiency and the fault information of the fan control apparatus.

The second processor 142 may perform an operation to protect the fan control apparatus based on the fault diagnosis source code and the fault response source code and may monitor whether or not there is the hardware fault.

The second processor 142 may learn individual air conditioning use types using machine learning.

Here, the learning means that a basic artificial intelligence model is learned using a plurality of learning data by a learning algorithm. Predefined operating rules or a new AI model set to perform a desired feature (alternatively, a desired objective) is created through learning of the basic artificial intelligence model.

The learning may be performed in a device itself where artificial intelligence is performed or may be performed through a separate server and/or system.

For example, the learning algorithm may include a supervised learning, unsupervised learning, semi-supervised learning, or reinforcement learning, without being limited thereto.

The AI model may be composed of a plurality of neural network layers.

Each of the plurality of neural network layers includes a plurality of weight values and performs a neural network computation through a computation between a computation result of a previous layer and the plurality of weight values.

The plurality of weight values of the plurality of neural network layers may be optimized by a learning result of the AI model. For example, the plurality of weight values may be updated so that a loss value or a cost value obtained from the AI model is reduced or minimized during a learning process.

The artificial neural network may include a deep neural network (DNN).

The artificial neural network may include a convolutional neural network (CNN), a recurrent neural network (RNN), a restricted Boltzmann machine (RBM), deep belief network (DBN), bidirectional recurrent deep neural network (BRDNN), deep Q-Networks, or the like, without being limited thereto.

The second processor 142 obtains region information based on location information of the location receiver provided in the communication device 120 and determines performance degradation based on the obtained region information and the performance parameters of the motor. When it is determined that the performance is degraded, the second processor 142 calibrates the software based on the region information and the performance parameters of the motor.

Here, the calibration of the software may be the update of the software.

The second processor 142 may calibrate input sources other than the input current and speed of the motor based on the region information.

When the use time of the air conditioner exceeds a reference time, the second processor 142 determines that the performance degradation due to the use time exceeding, identifies the first and second optimization performance points corresponding to the use time exceeding the reference time from the big data, and changes the operating point of the motor based on the first and second optimization performance points.

The second processor 142 determines whether the performance of the air conditioner has deteriorated due to the use time. In other words, the second processor 142 may identify temperature information of the fan control apparatus 140b detected by a temperature sensor (not shown) provided in the fan control apparatus and may change the operating point of the motor based on the identified temperature information of the fan control apparatus.

The second processor 142 may control the memory 143 to store motor control information for power increase control corresponding to the temperature information of the fan control apparatus.

The motor control information may include speed fixing information, input source change information, and torque calibration information.

The second processor 142 determines the fault of at least one of overcurrent, undercurrent, high voltage, short circuit of the fan control apparatus, motor restraint, circuit damage of the fan control apparatus due to high temperature, software current limit, hardware current limit, and low power circuit protection mode at hardware high temperature based on the performance parameters of the motor and the fault diagnosis source code stored in the memory.

The second processor 142 may transmit the determined fault information, the identification information of the vehicle, and the region information to the server 2. In this case, the server 2 may identify and store fault information by vehicle type and fault information by region and provide the stored information to vehicles as the big data.

The vehicle of the disclosure can protect the hardware of the fan control apparatus and can improve efficiency by storing only the fault diagnosis source code for fault diagnosis.

The vehicle can reduce the physical data storage space of memory of the fan control apparatus of the vehicle by using the big data.

Since the vehicle according to the present embodiments stores only reference data for determining the performance degradation and information for diagnosing the fault in memory, it is possible to minimize data storage space in memory.

Through this, the efficiency and the durability of the fan control apparatus can be improved.

In this embodiment, the torque data and efficiency may be obtained using voltage data, the current data, and the speed data of the motor, and the performance degradation may be determined.

The second processor 142 receives state of charge information on the state of charge of the battery from the battery management device (not shown) and determines whether the charge rate of the battery is greater than or equal to a reference charge rate based on the received state of charge information of the battery. When it is determined that the charge rate is higher than the reference charge rate, the speed of the motor may be increased to quickly reach the indoor target temperature.

To quickly reach the interior target temperature includes obtaining, by the second processor, the speed of the motor based on the detected interior temperature, the interior target temperature, and an operating rate of the air conditioner. When the fan is operated at the obtained motor speed, a time to reach the interior target temperature is estimated and the interior target temperature is reached in a faster time than the estimated time.

The state of change (SOC) information of the battery may include a charge rate of the battery.

The increasing the motor speed includes rotating the motor at a speed higher than the obtained speed of the motor.

The memory 143 may store the reference charge rate and store the big data.

The memory 143 may store the reference data, the first and second reference performance curve maps, and information on first and second initial performance points.

The information on the first initial performance point may include the position information of the first initial performance point. The information on the first initial performance point may include the voltage data, the speed data, and the current data.

The information on the second initial performance point may include the position information of the second initial performance point.

The information on the second initial performance point may include the voltage data, the speed data, and the efficiency data.

The memory 143 may store information about the predetermined size of area for setting the first and second boundary areas.

The memory 143 may store the fault diagnosis source codes and the fault response source codes.

The memory 143 may be a memory implemented as a chip separate from the processor described above in relation to the second processor 142 or may be implemented as a single chip with the second processor 142.

The memory 143 may be implemented as at least one of a non-volatile memory device such as a cache, a ROM (read only memory), a PROM (programmable ROM), an EPROM (erasable programmable ROM), an EEPROM (electrically erasable programmable ROM), or a flash memory, a volatile memory device such as a RAM (random access memory), or a storage medium such as a HDD (hard disk drive) or a CD-ROM, but is limited thereto.

As should be apparent from the above, according to the embodiments of the disclosure, the state of the fan control apparatus can be constantly monitored, and the performance of the motor can be separately monitored.

According to the embodiments of the disclosure, it is possible to determine whether or not the performance is degraded based on the use information of the air conditioner, region information, and the performance parameters of the motor.

According to the embodiments of the disclosure, the performance of the fan can be improved by controlling the motor in response to the performance degradation of the fan control apparatus.

According to the embodiments of the disclosure, it is possible to diagnose the fault of the fan control apparatus and output the confirmation information for handling the fault as the message so that the user can quickly respond to the fault.

According to the embodiments of the disclosure, the fault of the fan can be solved by diagnosing the fault of the fan control apparatus and executing the fault response source code in response to the diagnosed fault.

According to the embodiments of the disclosure, it is possible to reduce the data storage space of memory by using the big data.

According to the embodiments of the disclosure, it is possible to minimize the data storage space of a memory by storing only data corresponding to the reference data for determining durability performance, fault diagnosis source code for fault diagnosis, and fault response source code in memory. Through this, it is possible to improve the efficiency and durability of the fan control apparatus and the motor.

According to the embodiments of the disclosure, it is possible to improve the accuracy of fault diagnosis by diagnosing the fault using eight (8) types of fault diagnosis source codes to protect the hardware of the fan control apparatus, and to perform high-efficiency operation by quickly responding to fault.

According to the embodiments of the disclosure, it is possible to improve quality and marketability of the fan control apparatus and the vehicle, and to further increase user satisfaction, improve vehicle safety, and secure product competitiveness.

Meanwhile, embodiments can be stored in the form of a recording medium storing computer-executable instructions. The instructions may be stored in the form of a program code, and when executed by a processor, the instructions may perform operations of the disclosed embodiments. The recording medium may be implemented as a computer-readable recording medium.

The computer-readable recording medium includes all kinds of recording media in which instructions which may be decoded by a computer are stored of, for example, a read only memory (ROM), random access memory (RAM), magnetic tapes, magnetic disks, flash memories, optical recording medium, or the like.

Although embodiments have been described for illustrative purposes, those of ordinary skill in the art should appreciate that various modifications, additions, and substitutions are possible without departing from the scope and spirit of the disclosure. Therefore, embodiments have not been described for limiting purposes.

What is claimed is:

1. A fan control apparatus comprising:
a communication interface configured to receive performance parameters of a motor provided in a fan;
a memory configured to store reference data; and
a processor configured to
generate first and second reference performance curve maps based on the reference data stored in the memory,
periodically generate first and second performance points based on the performance parameters of the motor received by the communication interface,
identify a positional change of the first performance point periodically generated on the first reference performance curve map,
identify a positional change of the second performance point periodically generated on the second reference performance curve map, and
determine whether a performance of the fan is decreased based on the positional change of the first performance point and the positional change of the second performance point.

2. The fan control apparatus according to claim 1, wherein the performance parameters of the motor include current data of the motor, voltage data of the motor, and speed data of the motor.

3. The fan control apparatus according to claim 1, wherein, in response to operation of the fan at an initial time, the processor is configured to obtain first current data, first voltage data, and first speed data of the motor, to generate a first initial performance point based on the obtained first current data and the obtained first speed data, and to generate a second initial performance point based on the obtained first voltage data and the obtained first speed data.

4. The fan control apparatus according to claim 3, wherein the processor is configured to set a first boundary area based on position information of the first initial performance point on a first performance map and to set a second boundary area based on position information of the second initial performance point on a second performance map.

5. The fan control apparatus according to claim 4, wherein the processor is configured to:
in response to operation of the fan at a present time, obtain second current data, second voltage data, and second speed data of the motor;
generate a first present performance point based on the obtained second current data and the obtained second speed data;
generate a second present performance point based on the obtained second voltage data and the obtained second speed data;
in response to mapping the first present performance point to the first performance map, determine that the performance of the fan is changed, based on the first present performance point being located outside the first boundary area of the first performance map; and
in response to mapping the second present performance point to the second performance map, determine that the performance of the fan is changed, based on the second present performance point being located outside the second boundary area of the second performance map.

6. The fan control apparatus according to claim 3, wherein the processor is configured to:
in response to operation of the fan at a present time, obtain second current data, second voltage data, and second speed data of the motor;
generate a first present performance point based on the obtained second current data and the obtained second speed data;
generate a second present performance point based on the obtained second voltage data and the obtained second speed data;
map the first initial performance point and the first present performance point to the first reference performance curve map;
determine a positional change of the first present performance point based on a position of the first initial performance point on the mapped first performance map;
map the second initial performance point and the second present performance point to the second reference performance curve map;
determine a positional change of the second present performance point based on a position of the second initial performance point on the mapped second performance map; and
determine whether the performance of the fan is decreased based on the positional change of the first present performance point and the positional change of the second present performance point.

7. The fan control apparatus according to claim 6, wherein the processor is configured to determine a direction of the positional change of the first present performance point corresponding to the positional change of the first present performance point and to determine a direction of the positional change of the second present performance point corresponding to the positional change of the second present performance point.

8. The fan control apparatus according to claim 7, wherein the processor is configured to determine a cause of a decrease in performance of the fan corresponding to the direction of the positional change of the first present performance point and the direction of the positional change of the second present performance point based on big data received by a server.

9. The fan control apparatus according to claim 6, wherein, based on a determination that the performance of the fan is decreased, the processor is configured to obtain a first optimization performance point based on position information of the first initial performance point to obtain a second optimization performance point based on position information of the second initial performance point, and to update software for controlling the fan based on the first optimization performance point and the second optimization performance point.

10. The fan control apparatus according to claim 9, wherein the processor is configured to change an operation point of the motor through the update of the software.

11. The fan control apparatus according to claim 1, wherein the memory is configured to store a fault diagnosis source code and a fault response source code, and wherein the processor is configured to determine a fault based of the fault diagnosis source code stored in the memory and to control a fault response based on the fault response source code stored in the memory based on a determination of the fault.

12. A vehicle comprising:
an air conditioner including a fan coupled to a motor;
a current sensor configured to detect a current of the motor;
a speed sensor configured to detect a rotational speed of the motor;
a voltage sensor configured to detect a voltage of the motor;
a communication device configured to receive performance parameters of a motor;
a memory configured to store reference data; and
a fan control apparatus configured to
generate first and second reference performance curve maps based on the reference data stored in the memory,
periodically generate first and second performance points based on the performance parameters of the motor received by the communication device,
identify a positional change of the first performance point periodically generated on the first reference performance curve map,
identify a positional change of the second performance point periodically generated on the second reference performance curve map, and
determine whether a performance of the fan is decreased based on the positional change of the first performance point and the positional change of the second performance point.

13. The vehicle according to claim 12, wherein, in response to operation of the fan at an initial time, the fan control apparatus is configured to obtain first current data, first voltage data, and first speed data of the motor, to generate a first initial performance point based on the obtained first current data and the obtained first speed data, and to generate a second initial performance point based on the obtained first voltage data and the obtained first speed data.

14. The vehicle according to claim 13, wherein the fan control apparatus is configured to set a first boundary area based on position information of the first initial performance point on a first performance map and to set a second boundary area based on position information of the second initial performance point on a second performance map.

15. The vehicle according to claim 14, wherein the fan control apparatus is configured to:
in response to operation of the fan at a present time, obtain second current data, second voltage data, and second speed data of the motor;
generate a first present performance point based on the obtained second current data and the obtained second speed data;
generate a second present performance point based on the obtained second voltage data and the obtained second speed data;
in response to mapping the first present performance point to the first performance map, determine that the performance of the fan is changed, based on the first present performance point being located outside the first boundary area of the first performance map; and
in response to mapping the second present performance point to the second performance map, determine that the performance of the fan is changed, based on the second present performance point being located outside the second boundary area of the second performance map.

16. The vehicle according to claim 15, wherein the communication device is configured to communicate with a server, and wherein the fan control apparatus is configured to:
determine a direction of the positional change of the first present performance point corresponding to the positional change of the first present performance point;
determine a direction of the positional change of the second present performance point corresponding to the positional change of the second present performance point; and
determine a cause of a decrease in performance of the fan corresponding to the direction of the positional change of the first present performance point and the direction of the positional change of the second present performance point based on big data received by the server.

17. The vehicle according to claim 16, wherein, based on a determination that the performance of the fan is decreased, the fan control apparatus is configured to:
obtain a first optimization performance point based on position information of the first initial performance point;
obtain a second optimization performance point based on position information of the second initial performance point;
update software for controlling the fan based on the first optimization performance point and the second optimization performance point; and
change an operation point of the motor through the update of the software.

18. The vehicle according to claim 12, wherein, when determining whether the performance of the fan is decreased, the fan control apparatus is configured to identify use information and region information of the air conditioner and to determine whether the performance of the fan is decreased based on the identified use information and the identified region information of the air conditioner.

19. The vehicle according to claim 12, wherein the memory is configured to store a fault diagnosis source code and a fault response source code, and wherein the fan control apparatus is configured to determine a fault based of the fault diagnosis source code stored in the memory and to control a fault response based on the fault response source code stored in the memory based on a determination of the fault.

20. The vehicle according to claim 19, further comprising:
a display device, wherein the fan control apparatus is configured to control the display device to display a fault code and a confirmation message for responding to the fault based on the determination of the fault.
